(19) United States
(12) Patent Application Publication
(10) Pub. No.: US 2005/0147535 A1
(43) Pub. Date: Jul. 7, 2005

(54) Apparatus for synthesis of radiolabeled compounds

(76) Inventors: Seth Shulman, Washington, DC (US); Alan A Wilson, Toronto (CA); Michael T Scardina, Alexandria, VA (US); Michell D Albers, Vienna, VA (US); Vincent L Tadino, Washington, DC (US)

Correspondence Address: BURNS DOANE SWECKER & MATHIS L L P, POST OFFICE BOX 1404, ALEXANDRIA, VA, 22313-1404, US

(21) Appl. No.: 10/502,983

(22) PCT Filed: Jan. 31, 2003
(86) PCT No.: PCT/US03/03055

Related U.S. Application Data
(60) Provisional application No. 60/352,592, filed on Jan. 31, 2002.

(51) Int. Cl. B01L 3/00

(52) U.S. Cl. 422/99

(57) ABSTRACT

A system for radiolabeling compounds with a labeling module, which is fluidly connectable to a solvent delivery module, an HPLC pump and an HPLC column. The labeling module includes a loop and valves having different orientations to provide different fluid pathways of solvent, radiolabeling agent and inert gas through the system.

### BACKGROUND OF THE INVENTION

1. Field of the Invention

The present invention relates to systems and methods useful for the synthesis of radiolabeled compounds, and in particular to systems and methods useful for methylation, and for the addition of other groups for which a reactive precursor exists as a gas or with a substantial vapor pressure.

2. Brief Description of the Related Art

U.S. provisional patent application No. 60/265,126, filed Feb. 7, 2001, entitled “Method for the Synthesis of Radiolabeled Compounds”, by Alan A. Wilson, Armando Garcia, Li Jin, and Sylvain Houle (“'126 Provisional Application”), the entirety of which is incorporated by reference herein, describes methods and a system for radiolabeling compounds.

### SUMMARY OF THE INVENTION

According to a first aspect of the invention, a system useful for methylation or other labeling of a compound comprises: a first input for connection to a source of methyl iodide or other gaseous or high vapor pressure reactive component; a second input for connection to a source of a solvent and inert gas; a third input for connection to an HPLC (high performance liquid chromatography) pump; an output for connection to an HPLC column; a loop having first and second ports; a first valve in fluid communication with the first input and the second input, the first valve having an output and first and second orientations; a second valve in fluid communication with the third input, the first valve output, and the output, the second valve having first and second orientations; a third valve in fluid communication with the loop first and second ports, and with the second valve, the third valve having first and second orientations; and a plurality of fluid pathways fluidly connecting the first input, second input, third input, output, first valve, second valve, and third valve; wherein the plurality of fluid pathways in the first orientation of the first valve, of the second valve, and of the third valve, fluidly connect the first valve output through the second valve to the third valve and back to the second valve; wherein the plurality of fluid pathways in the first orientation of the first valve, of the second valve, and of the third valve, fluidly connect the third valve with the loop ports and back to the third valve; and wherein the plurality of fluid pathways in the first orientation of the first valve, of the second valve, and of the third valve, fluidly connect the third input to the output through the second valve.

According to another aspect of the present invention, the plurality of fluid pathways in the first orientation of the second valve and in the second orientation of the third valve fluidly connect the output of the first valve to the second valve, the second valve to the third valve, the third valve to the loop, the loop back to the third valve, and the third valve back to the second valve, and the second valve with the output.

According to another aspect of the present invention, the plurality of fluid pathways in the second orientation of the first valve, of the second valve, and of the third valve, fluidly connect the third input to the second valve, the second valve to the third valve, the third valve with a loop port, the other loop port with the third valve, the third valve back with the second valve, and the second valve with the output.

According to another aspect of the present invention, the system further comprises a solvent source having an output in fluid communication with the second input, the solvent source including a plurality of sources of different solvents, and a valve in fluid communication with each of the plurality of sources of solvents, the valve having a plurality of orientations which selectively fluidly connect a single solvent source in fluid communication with the solvent source outlet.

According to another aspect of the present invention, the system further comprises a pressurized source of an inert gas in fluid communication with each of the plurality of sources of different solvents.

According to another aspect of the present invention, the system further comprises a radioisotope detector proximal to the loop.

According to another aspect of the present invention, the system further comprises a source of methyl iodide or other gaseous or high vapor pressure reactive component in fluid communication with the first input.

According to another aspect of the present invention, the system further comprises an HPLC pump in fluid communication with the third input.

According to another aspect of the present invention, the system further comprises an HPLC column in fluid communication with the output.

According to another aspect of the present invention, the system further comprises a control module in control communication with at least one of the first valve, the second valve, and the third valve.

According to another aspect of the present invention, the system further comprises a control module in control communication with at least one of the first valve, the second valve, the third valve, and the solvent source valve.

Still other objects, features, aspects, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to preferred embodiments of the apparatus and method, given only by way of example, and with reference to the accompanying drawings, in which:

FIG. 1 is a schematic view of an apparatus and flow diagram for trapping a radiolabeling reagent in an HPLC loop coated with a precursor solution, as described in the '126 Provisional Application.

FIG. 2 is a schematic view of fluid flow components used in an automated apparatus for radiolabeling reactions, as described in the '126 Provisional Application.

FIG. 3 schematically illustrates a exemplary system in accordance with the present invention.

FIG. 4 schematically illustrates a portion of the system illustrated in FIG. 3.

FIG. 5 schematically illustrates first positions of two of the valves of the system illustrated in FIGS. 3 and 4.

FIG. 6 schematically illustrates second positions of two of the valves of the system illustrated in FIGS. 3 and 4.

FIG. 7 schematically illustrates third positions of two of the valves of the system illustrated in FIGS. 3 and 4.

FIG. 8 schematically illustrates an alternative embodiment of a portion of the system shown in FIG. 3.

### DESCRIPTION OF THE PREFERRED EMBODIMENTS

Referring to the drawing figures, like reference numerals designate identical or corresponding elements throughout the several figures.

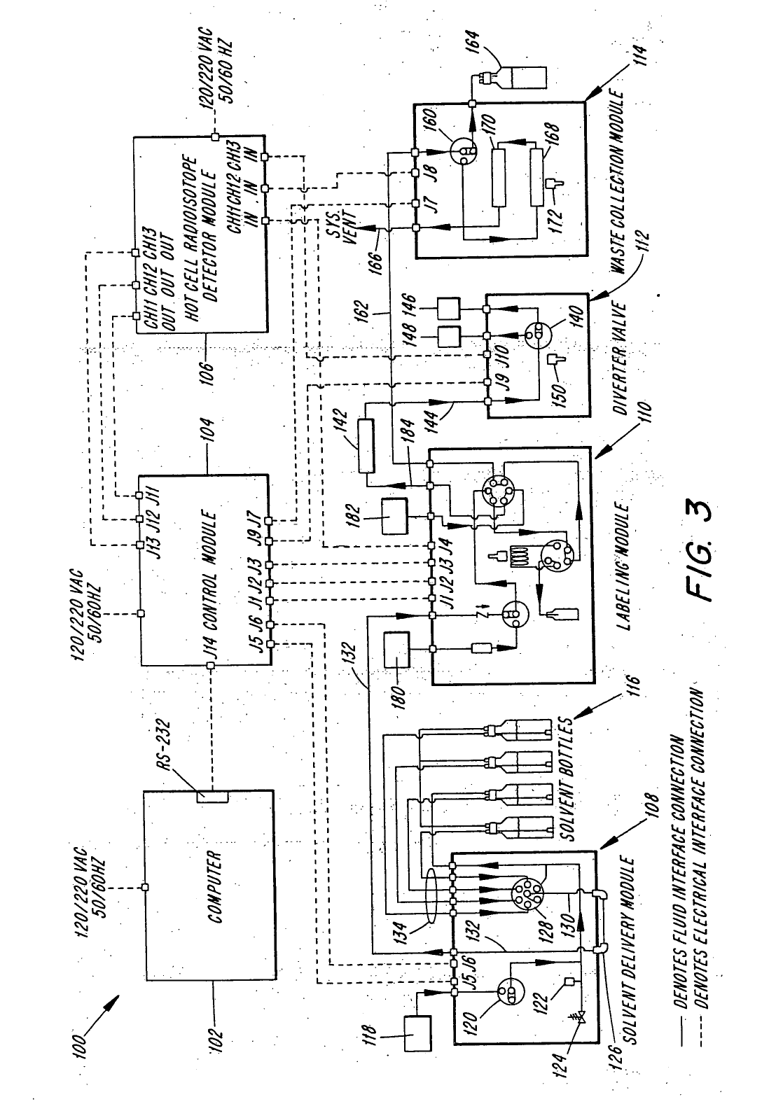

FIG. 3 illustrates a system 100 in accordance with the present invention. Those of ordinary skill in the art readily appreciate the function and operation of HPLC systems, and therefore some details have not been provided so as not to obfuscate the invention.

The system 100 includes a computer 102, a control module 104, a hot cell radioisotope detector module 106, a solvent delivery module 108, a labeling module 110, a diverter valve module 112, and a waste collection module 114. FIG. 3 illustrates the several modules and components of the system 100 interconnected together by a plurality of electrical control lines (broken line) and fluid communication lines (solid line). Those of skill in the art will appreciate that the fluid lines are preferably formed of materials that do not react with or otherwise affect the fluids (liquids or gases) that are to flow through the fluid lines, and, based upon the selection of the fluids that are to flow through the lines, the skilled artisan can readily select a suitable material. By way of example and not of limitation, the fluid lines can be formed of ETFE tubing, although other materials are within the scope of the present invention.

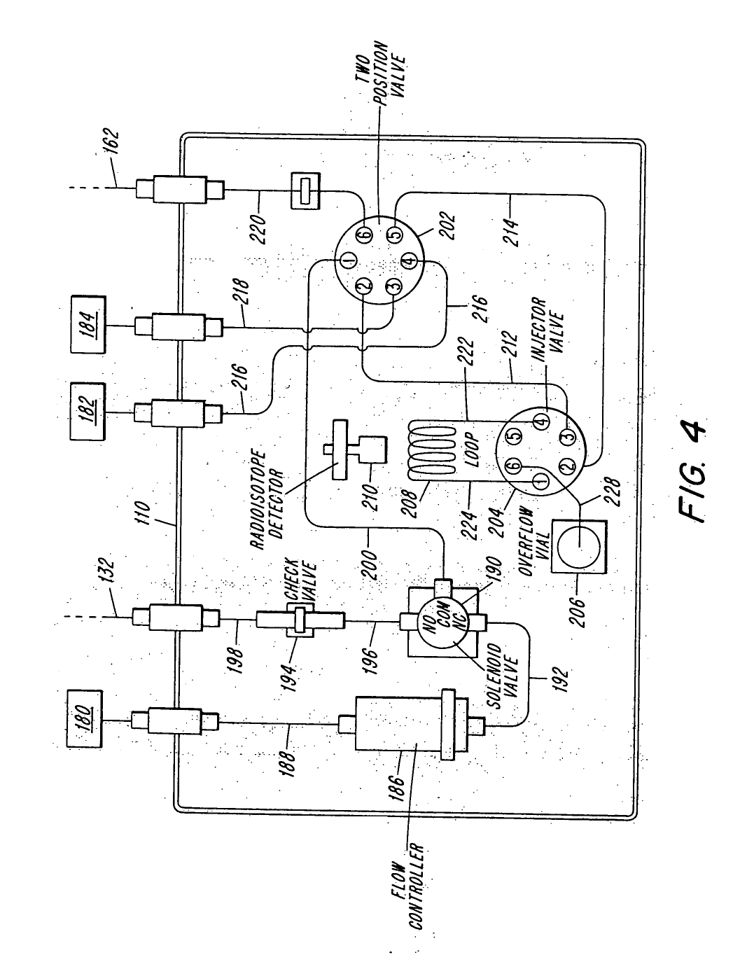

The computer module 102 is in communication with, or incorporates, logic, which produces control signals for the control module 104 so that the system 100 functions as described herein. Those of skill in the art will appreciate that the logic can be embodied in software instructions stored in an accessible memory, digital logic circuits, analog logic circuits, or combinations thereof, within the scope of the present invention. In turn, the control module 104 is in communication with the hot cell radioisotope detector module 106, the solvent delivery module 108, the labeling module 110, the diverter valve module 112, and the waste collection module 114 via control lines. The control module 104 provides control signal(s) to each of the modules so that each functions in accordance with the control signals received from the computer 102, and as described herein and in the '126 Provisional Application. FIG. 3 illustrates the fluid flow lines including arrows, which indicate the direction of flow of fluids through the lines when the numerous components of the system 100 are oriented or otherwise controlled to be in a first orientation. The first and second and third orientations of the system 100 are illustrated in FIGS. 4-7.

According to yet further aspects of the invention, some or all of the elements of the system 100, which are described herein as being controlled by the control module 104, can be manual elements, e.g., manually operated valves.

The detector module 106 is in communication with each of the radioisotope detectors provided in the system 100, and provides feedback signals to the control module 104. In the exemplary system 100, there are three radioisotope detectors provided, one in each of the labeling module 110, the diverter valve module 112, and the waste collection module 114, although some of the radioisotope detectors can be eliminated without detracting from the invention.

The solvent delivery module 108 includes or is in fluid communication with at least one, and preferably a plurality, of sources 116 of solvents, and a pressurized source 118 of inert gas. While the exemplary system 100 includes four such solvents, acetone, water, NaOH, and ether, with corresponding numbers of fluid lines and valving, those of skill in the art will appreciate that more or fewer solvents, different solvents, and mixtures of solvents and inert gas, such as, nitrogen, can be delivered without departing from the present invention. The pressurized source 118 of inert gas preferably delivers nitrogen gas to the module 108.

The solvent delivery module 108 includes a valve 120, pressure transducer 122, pressure relief valve 124, a flow sight tube 126 positioned so that an operator of the system 100 can visually observe the flow sight tube, and a solvent selector valve 128. The valves 120 and 128 are in control communication with the control module 104, which controls the positions of these valves. The pressure transducer 122 may be included to provide a feedback control signal to the control module 104.

Each of the individual sources 116 of solvent are fluidly connected via fluid line(s) 134 to a separate port of the solvent valve 128; when the solvent valve is controlled by the control module 104, or manually operated when it is a manual valve, one of the solvent sources is placed in fluid communication with the flow sight tube 126 via fluid line 130, and from the sight tube to the labeling module 110 via a fluid line 132. The source of pressurized inert gas, e.g., nitrogen, is in communication with all of the solvent sources 116 through the valve 120, and is used to pressurize the solvent source containers to drive the solvents through the solvent selector valve 128 and to the labeling module 110. The inert gas may also be regulated within the solvent delivery module 108 for delivery at a desired rate, such as a present flow rate, in place of a liquid solvent as may be suitable to condition chemicals inside the loop 208 and keep air from entering the loop, which may reduce the reactivity of chemicals in the loop. When the solvent selector valve 128 is appropriately controlled, the pressurized source 118 is in fluid communication with fluid line 130, and thus only pressurized gas is delivered to the labeling module 110.

The labeling module 110 will be described in greater detail below.

The diverter valve module 112 includes a valve 140 controlled by the control module 104, or manually operated when it is a manual valve. The diverter valve module 112 receives fluid from an HPLC column 142 fluidly between the labeling module 110 and the diverter valve module, both described in greater detail below, along a fluid line 144. The diverter valve module 112 includes two fluid output lines 146, 148, one to a sample collector, and one to an HPLC liquid waste collector (neither illustrated). The diverter valve module 112 preferably includes a radioisotope detector 150, which is in communication with the radioisotope detector module 106, described above.

The waste collection module 114 includes a valve 160, which is in fluid communication with a fluid line 162 from the labeling module 110. The valve 160 is controlled by the control module 104 (or manually operated when it is a manual valve) to place the fluid line 162 in communication with either a liquid waste collection bottle 164, or with a system vent 166 through a charcoal filter 168 and a flow meter 170. The waste collection module 112 preferably includes a radioisotope detector 172, which is in communication with the radioisotope detector module 106, described above.

Turning now to the labeling module 110, reference is made to FIGS. 3-7. The labeling module 110 includes three fluid inputs, two fluid outputs, and at least four control signal lines in communication with the control module 104 and the radioisotope detector module 106. A source 180 of radiolabeled reagents delivers methyl iodide or other gaseous or high vapor pressure reactive component to the labeling module 110 via a first fluid input, solvent is delivered to the labeling module through the fluid line 132 via a second input, and an HPLC pump 182 delivers fluid to the labeling module 110 via a third fluid input, as described elsewhere herein and/or in the '126 Provisional Application. A first fluid output is in fluid communication with the fluid line 162, described above, and a second fluid output leads to a fluid line 184 which is in fluid communication with the HPLC column 142.

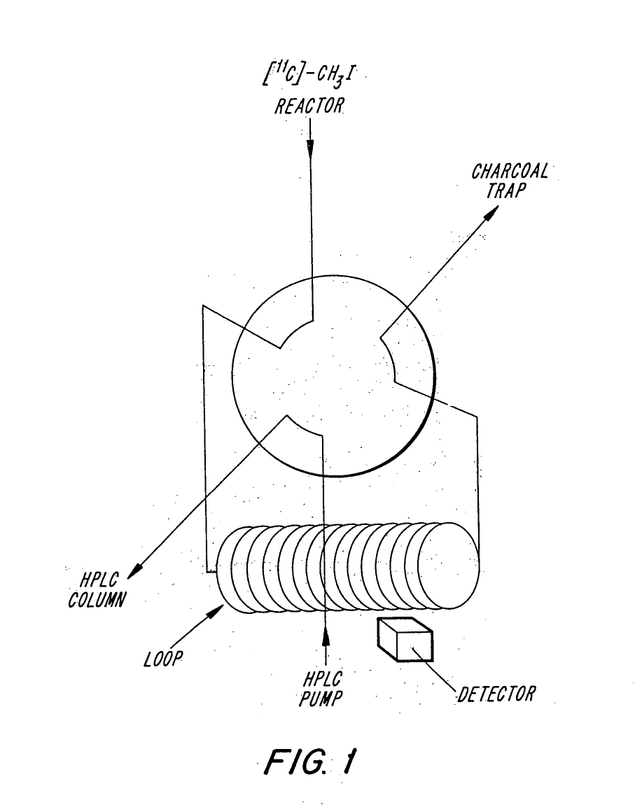

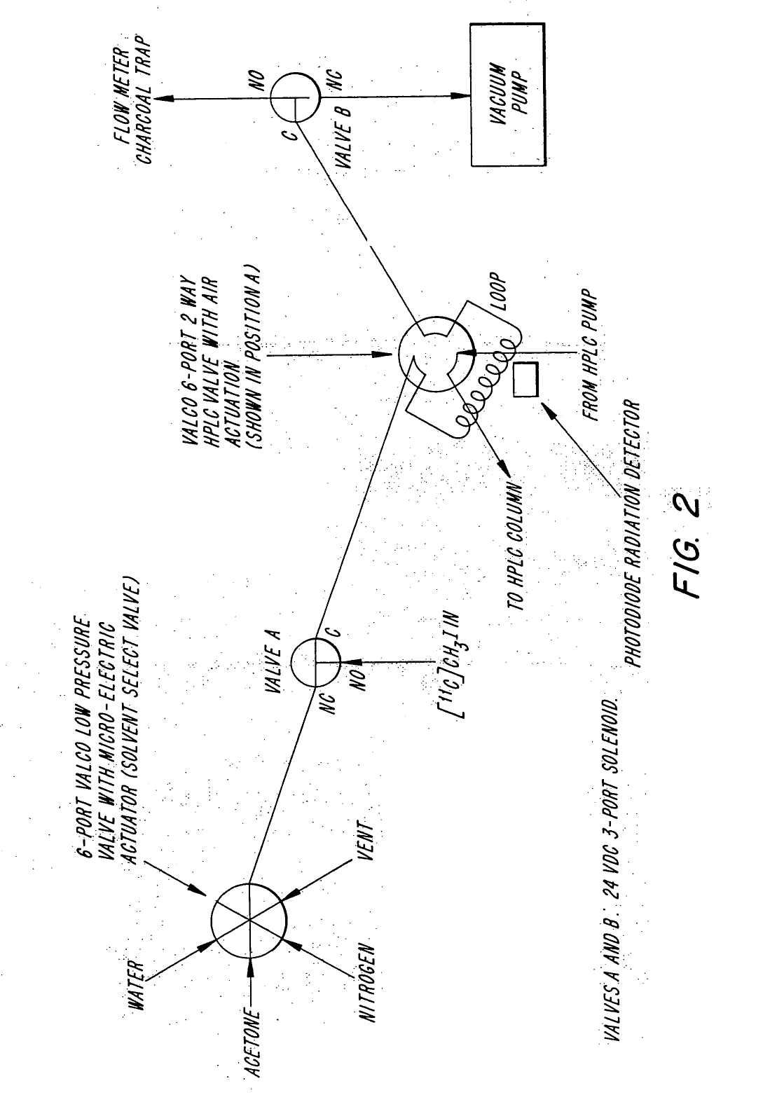

With reference to FIG. 4, the labeling module 110 includes a solvent selection valve 190, an injector valve 204, a valve 202, and a loop 208, which correspond to elements illustrated in FIGS. 1 and 2, described above. The loop 208 can be made of any suitable material, such as, for example, stainless steel, PEEK and the like, as will be readily appreciated. The volume of the loop 208 can be varied depending on factors including the particular reaction to be carried out, and can be readily optimized by those of ordinary skill in the art. In one exemplary embodiment, the loop 208 can have a volume between about 0.1 ml and 5 ml, alternatively between about 1 ml and 3 ml. The loop 208 also has a suitable internal surface area, that can be varied depending on factors including the particular reaction to be carried out, and can be readily optimized by those of ordinary skill in the art. In one exemplary embodiment, the loop 208 can have an internal surface area between about 1 and 100 cm², alternatively between about 40 and 80 cm².

The loop 208 can be at room temperature. Alternatively, the system 100 can include suitable heating and/or cooling capabilities to heat and/or cool the loop 208 to desired temperatures above and/or below room temperature.

Each of the valves is in control communication with and controlled by the control module 104. According to other aspects of the present invention, one, two, or all three of the valves 190, 202, 204, can be manual valves. Because of the possibility of exposure to radioactivity by an operator of the system 100, it is preferable that valves 190 and 202 are controlled by the control module 104. Alternatively, the valves 190 and 202 can be manual valves with an appropriately long actuator handle, or they can be shielded.

A fluid line 188 leads from fluid line 180 to a flow controller 186, which in turn is in fluid communication through a fluid line 192 with the valve 190. A fluid line 198 leads from fluid line 132 to the valve 190 through a fluid line 198, check valve 194, and a fluid line 196. In a first position of the valve 190, fluid line 192 is in fluid communication with fluid line 200, and in a second position of the valve 190, the fluid line 196 is in fluid communication with the fluid line 200.

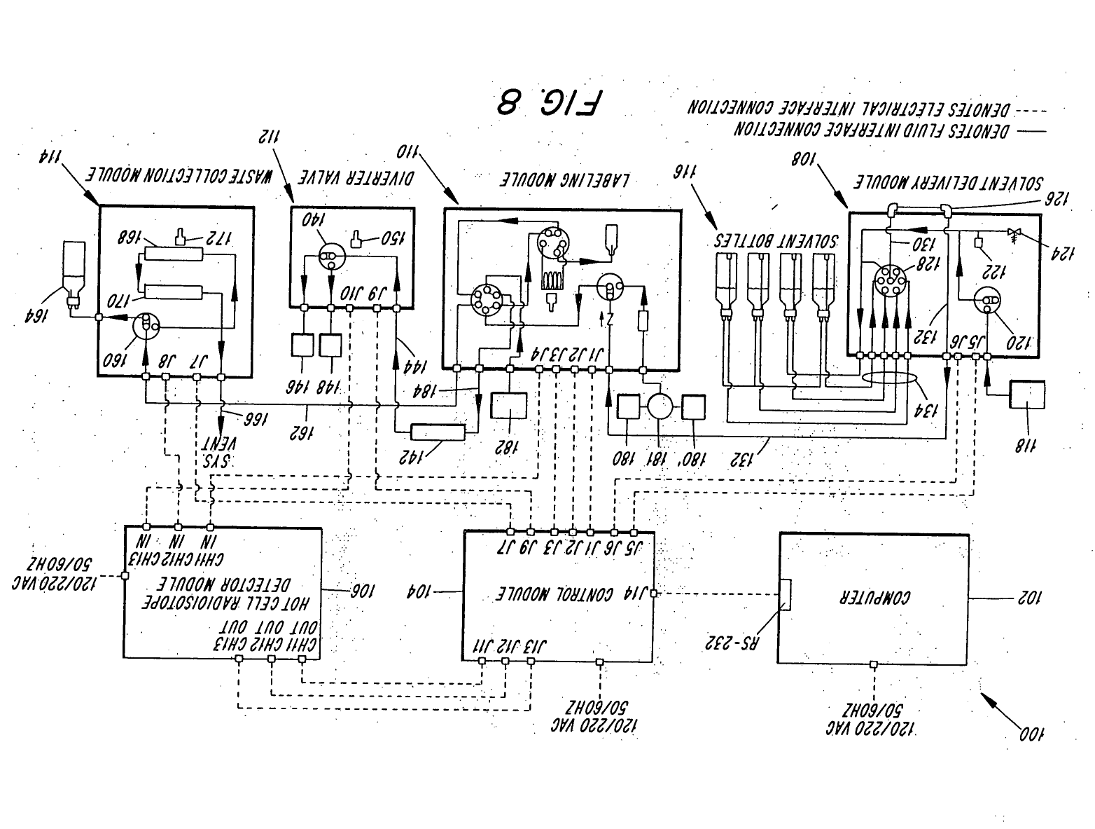

In an alternative embodiment, the system 100 can include an additional fluid line 180′ connected to a source of inert gas, such as nitrogen (FIG. 8). In this embodiment, the fluid line 180 is preferably connected to the fluid line 180′ via a valve 181, which is operable to selectively provide flow from either fluid line 180 or 180′ to the flow controller 186. The inert gas can be used to maintain and condition reactants in the loop 208 if gas flow from the generator may be interrupted during production of methyl iodide or other gaseous or high vapor pressure reactive component. This embodiment allows the supply of low flow gas to the precursor in the loop 208 if such gas flow may not be available at some desired time from the source of methyl iodide or other gaseous or high vapor pressure reactive component.

The injector valve 204 and the valve 202 each include, but are not limited to, six ports, to which reference will be made herein by the following nomenclature: valve number-port number. For example, port 1 of valve 202 is 202-1, port 3 of valve 204 is 204-3, and so forth. Fluid line 200 fluidly connects with 202-1, a fluid line 212 fluidly connects 202-2 with 204-3, a fluid line 214 fluidly connects 202-5 with 204-2, a fluid line 216 fluidly connects 202-4 with HPLC pump 182, and a fluid line 220 fluidly connects 202-6 with fluid line 162. Fluid line 228 fluidly connects 204-6 with the overflow vial or container 206. Fluid line 222 fluidly connects 204-4 with one end of loop 208, while fluid line 224 fluidly connects 204-1 with the other end of the loop 208. The labeling module 110 includes a radioisotope detector 210, which is in communication with the radioisotope detector module 106, described above.

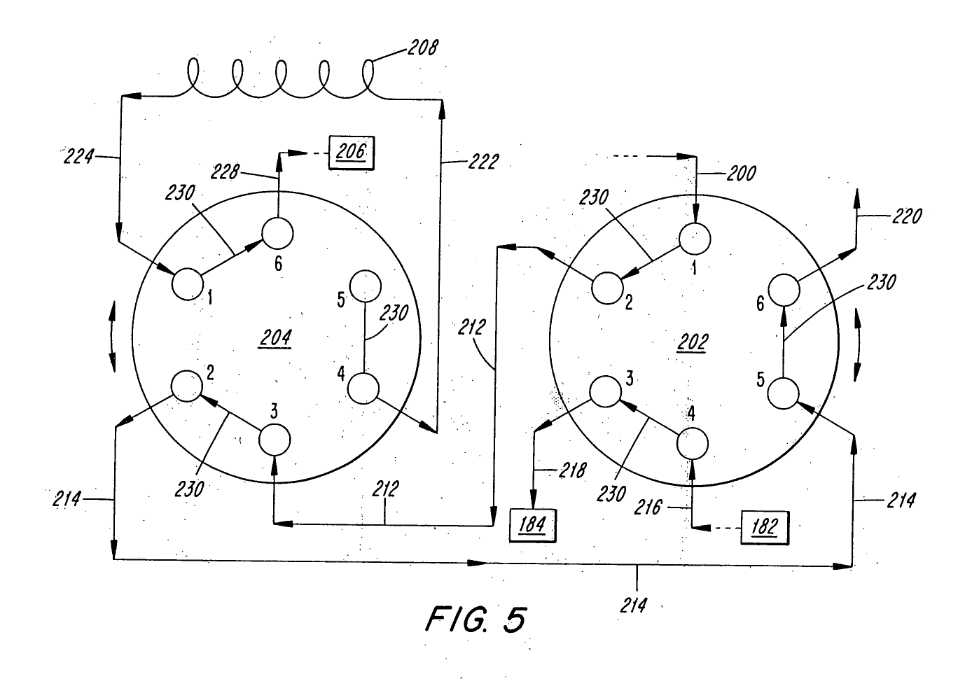

At least one of ports 204-4 and 204-5, preferably port 204-5, includes a pierceable septum (not illustrated) through which the operator of the system 100 can insert an injection needle (not illustrated) and inject a fluid, in particular the dissolved precursor (and base/catalyst if necessary) described above, into the loop 208. Both of the valves 202, 204 include a plurality of internal fluid pathways 230, schematically illustrated in FIGS. 5-7 as simple lines connecting the ports of the valves, each of which fluid pathways 230 fluidly connects two ports. Rotation of the valves 202, 204, moves the fluid pathways 230 to fluidly connect a different set of ports in each valve.

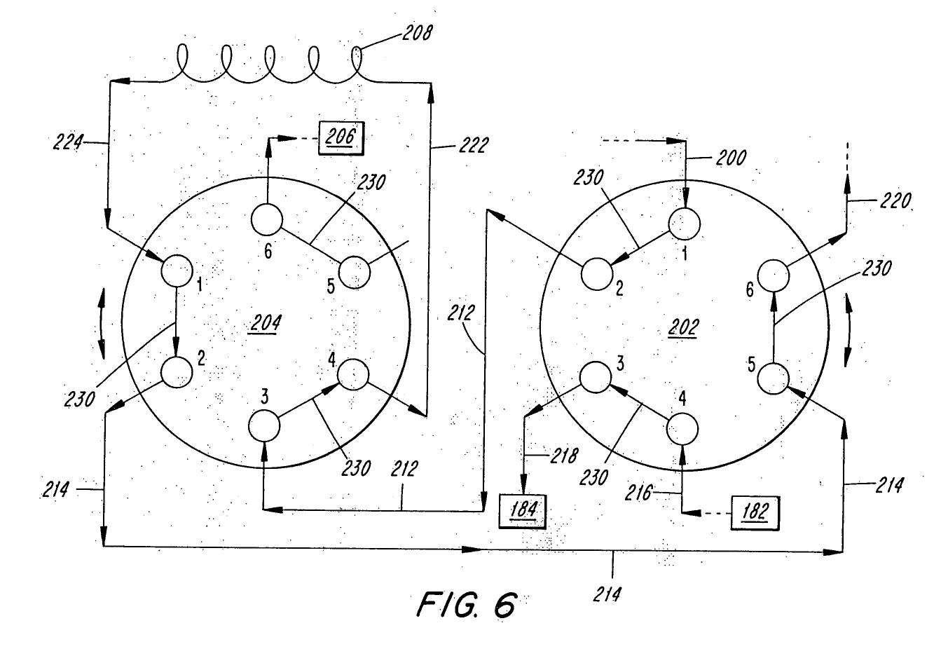

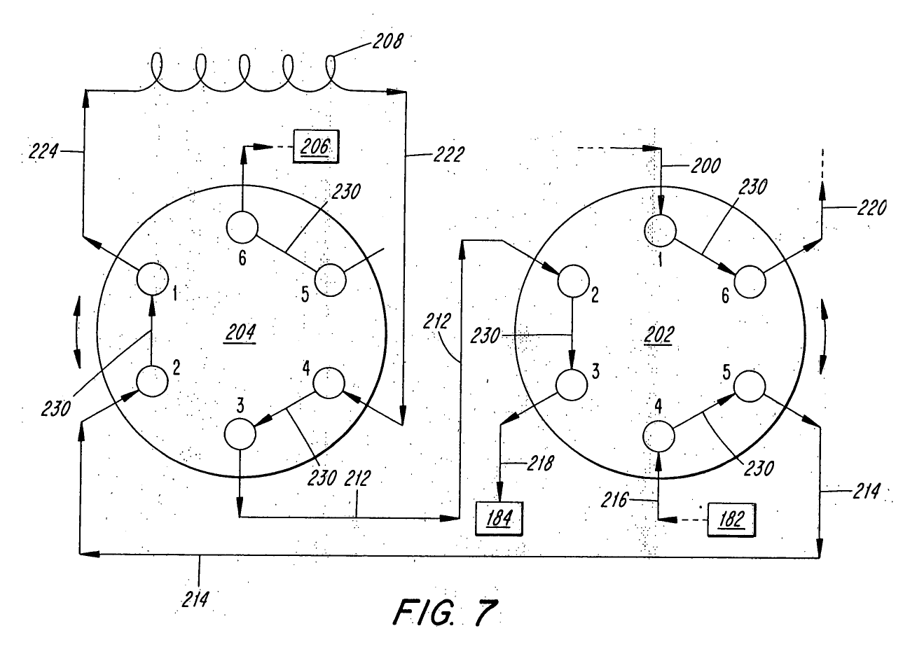

FIGS. 5-7 illustrate, in a simplified form, valves 202 and 204 in a first fluid configuration (FIG. 5), a second fluid configuration (FIG. 6), and a third fluid configuration (FIG. 7). The second fluid configuration is achieved by controlling the valve 204 to rotate one position either clockwise or counterclockwise, to place in fluid communication different sets of ports, and therefore to create different sets of fluid paths through the labeling module 110. The third fluid configuration is achieved by controlling the valve 202 to rotate one position either clockwise or counterclockwise from its position in the second configuration, to place in fluid communication yet different sets of ports, and therefore to create yet different sets of fluid paths through the labeling module 110.

In the first configuration, illustrated in FIG. 5, the following pairs of ports are in fluid communication: 202-1 and 202-2; 202-3 and 202-4; 202-5 and 202-6; 204-2 and 204-3; 204-4 and 204-5; 204-6 and 204-1. In the first configuration, the selected fluid (methyl iodide or other gaseous or high vapor pressure reactive component, solvent, or nitrogen gas) from valve 190 flows through line 200 to port 202-1, to port 202-2, through line 212 to port 204-3, to port 204-2, along line 214 to port 202-5, to port 202-6, and out to line 220 to the waste collection module 114. The HPLC pump 182 pumps fluid along line 216 to port 202-4, to port 202-3, out along line 218 to the HPLC column 184. Port 204-5 (and/or 204-4) can receive a fluid injection through the septum, described above, which flows out along line 222 to the loop 208, out line 224 to port 204-1, to port 204-6, and out along line 228 to the overflow vial 206. In this configuration, the loop 208 can be primed or loaded with the precursor.

The control module 104 then controls (or the operator manually operates, or combinations thereof) the valve 204 to position the system 100 in the second configuration, illustrated in FIG. 6, resulting in the following pairs of ports being in fluid communication: 202-1 and 202-2; 202-3 and 202-4; 202-5 and 202-6; 204-1 and 204-2; 204-3 and 204-4; 204-5 and 204-6. In the second configuration, the selected fluid (methyl iodide or other gaseous or high vapor pressure reactive component, solvent, or nitrogen gas) from valve 190 flows through line 200 to port 202-1, to port 202-2, out along line 212 to port 204-3, to port 204-4 and out along line 222 to the loop 208. The fluid exits the loop 208, flows along line 224 to port 204-1, to port 204-2, out along line 214 to port 202-5, to port 202-6, and out line 220. Port 204-5 communicates with port 204-6, but as no fluid pressure is present, there is no significant flow. The HPLC pump 182 pumps fluid along line 216 to port 202-4, to port 202-3, and out along line 218 to the HPLC column 184. In this second configuration, the system 100 can be settled by switching solvent valve 128 to pass inert gas to the labeling module 110 along line 132, and the methylation reaction can alternatively be run by switching valve 190 to feed methyl iodide or other gaseous or high vapor pressure reactive component into line 200.

The control module 104 then controls (or the operator manually operates, or combinations thereof) the valve 202 to position the system 100 in the third configuration, illustrated in FIG. 7, resulting in the following pairs of ports being in fluid communication: 202-2 and 202-3; 202-4 and 202-5; 202-6 and 202-1; 204-1 and 204-2; 204-3 and 204-4; 204-5 and 204-6. In the third configuration, the selected fluid (methyl iodide or other gaseous or high vapor pressure reactive component, solvent, or nitrogen gas) from valve 190 flows through line 200 to port 202-1, to port 202-6, and out to line 220. Port 204-5 communicates with port 204-6, but as no fluid pressure is present, there is no significant flow.

The HPLC pump 182 pumps fluid along line 216 to port 202-4, to port 202-5, and out along line 214 to port 204-2. From 204-2, the fluid flows to port 204-1, along line 224, through the loop 208, and out line 222 to port 204-4. From 204-4 the fluid flows to port 204-3, out along line 212 to port 202-2, to port 203-3, and out along line 218 to the HPLC column 184. Thereafter, the valves 128, 190, 202, and 204 can be controlled by the control module 104 (or manually, or combinations of manual and controlled) to return to the second configuration for system solvent cleaning, and the system 100 used again by returning the valves to the first configuration of FIG. 5.

By way of example and not of limitation, a valve suitable to be used as valve 202 is available from Valco Instruments So, Inc. (Houston, Tex.) as part number C2-2006EHX, a valve suitable to be used as valve 204 is available from Rheodyne L.P. (Rohnert Park, Calif.) as part number 77251, a valve suitable to be used as valve 190 is available from General Valve (Brookshire, Tex.) as part number 001-0028-900, and a radioisotope detector suitable to be used as any of the detectors described herein and/or in the '126 Provisional Application is available from Bioscan, Inc. (Washington, D.C.) as part number HC3100.

Various radiolabeling reagents that are naturally gaseous, or have a high vapor pressure, are susceptible to be carried by an inert gas flow, and are capable of dissolving in a liquid film to react with a suitable precursor to produce a desired radiolabeled compound can be used in embodiments of the system for labeling of compounds. Suitable radiolabeling agents include, but are not limited to, [¹¹C]-phosgene (COCl₂), [¹¹C]-cyanogene bromide (HCN), [¹¹C]-cyanogene bromide (BrCN), [¹¹C]-formaldehyde (H₂CO), [¹¹C]-carbon monoxide (CO), [¹¹C]-carbon dioxide (CO₂), [¹¹C]-methyl alcohol (CH₃OH), [¹¹C]-methyl iodide (CH₃I), [¹¹C]-methyl bromide (CH₃Br), [¹¹C]-methyl chloride (CH₃Cl), [¹¹C]-nitromethane (CH₃NO₂), [¹¹C]-methyl trifluoromethanesulfonate (CH₃SO₃CF₃), [¹¹C]-ethyl trifluoromethane sulfonate (CH₃CH₂SO₃CF₃), [¹¹C]-iodoethane (CH₃CH₂I), [¹¹C]-bromoethane (CH₃CH₂Br), [¹¹C]-chloroethane (CH₃CH₂Cl), [¹¹C]-ethanol (CH₃CH₂OH), [¹¹C]-iodopropane (CH₃CH₂CH₂I), [¹¹C]-bromopropane (CH₃CH₂CH₂Br), [¹¹C]-chloropropane (CH₃CH₂CH₂Cl), [¹¹C]-propyl trifluoromethanesulfonate (CH₃CH₂CH₂SO₃CF₃), [¹¹C]-propyl-p-toluenesulfonate (CH₃CH₂CH₂SO₃C₇H₇), [¹¹C]-acetyl iodide (CH₃COI), [¹¹C]-methyl p-toluenesulfonate (CH₃OSO₃C₇H₇), [¹¹C]-ethyl p-toluenesulfonate (CH₃CH₂SO₃C₇H₇), [¹¹C]-propanone (CH₃COCH₃), [¹⁸F]-fluorine (F₂), [¹⁸F]-bromofluoromethane (FCH₂BR), [¹⁸F]-fluoromethyl trifluoromethanesulfonate (FCH₂SO₃CF₃), [¹⁸F]-fluoroiodomethane (FCH₂I), [¹⁸F]-1-bromo-2-fluoroethane (FCH₂CH₂Br), [¹⁸F]-1-iodo-2-fluoroethane (FCH₂CH₂I), [¹⁸F]-bromofluoropropane (BrCH₂CH₂CH₂F), [¹⁸F]-trifluoromethanesulfonic acid 3-fluoropropyl ester (FCH₂CH₂CH₂SO₃CF₃), [¹⁸F]-bromofluorobutane (BrCH₂CH₂CH₂CH₂F), [¹⁸F]-trifluoromethanesulfonic acid 4-fluorobutyl ester (FCH₂CH₂CH₂CH₂SO₃CF₃), [¹⁸F]-trifluoromethanesulphonic acid 2-fluoroethyl ester (FCH₂CH₂SO₃CF₃), [¹⁸F]-fluoromethyl p-toluenesulfonate (FCH₂SO₃C₇H₇) and [¹⁸F]-2-fluoroethyl-1-p-toluenesulfonate (FCH₂CH₂SO₃C₇H₇). Different radiolabeling reagents can be added to the precursor depending on the precursor used and the reactive site at which it is attached.

Various suitable solvents can be used in embodiments of the system for labeling of compounds. Such solvents preferably (i) are capable of dissolving a sufficient amount of precursor and capturing and dissolving a sufficient amount of radiolabeling reagent, (ii) are inert with respect to both the precursor and the radioactive substrate, and (iii) have a low vapor pressure, which allows the solvent to create a film on the sidewall of the loop and not be removed by pre-conditioning gas flow or the gas mixture of the radiolabeling agent and inert carrier gas.

While the invention has been described in detail with reference to preferred embodiments thereof, it will be apparent to one skilled in the art that various changes can be made, and equivalents employed, without departing from the scope of the invention. Each of the aforementioned documents is incorporated by reference herein in its entirety.

1. A system for the synthesis of radiolabeled compounds, comprising:
a first input fluidly connectable to a radiolabeling reagent source;
a second input fluidly connectable to a solvent and inert gas source;
a third input fluidly connectable to an HPLC pump;
a loop;
a first valve in fluid communication with the first input and second input, the first valve having different selectable orientations;
a second valve in fluid communication with the third input, the second valve having a first output fluidly connectable to an HPLC column, a second output and different selectable orientations;
a third valve in fluid communication with the loop, the second valve having different selectable orientations; and
a plurality of fluid pathways fluidly connecting the first input, the second input, the third input, the first output, the second output, the first valve, the second valve and the third valve;
wherein the system is positionable in different fluid configurations by placing the first valve, second valve and third valve in respective selected orientations, the fluid pathways provide different fluid connections between the first input, the second input, the third input, the first output, the second output, the first valve, the second valve and the third valve in the different fluid configurations of the system.

2. The system of claim 1, which has a first fluid configuration in which the second valve and third valve are in respective first orientations, wherein:
the loop contains a precursor reactive with the radiolabeling reagent to produce a radiolabeled compound;
(i) the radiolabeling reagent is flowed via the first input from the radiolabeling reagent source, (ii) the solvent is flowed via the second input from the solvent and inert gas source, or (iii) inert gas is flowed from an inert gas source, to (iv) the second valve, to the third valve, back to the second valve and to the second output of the second valve;
fluid is pumped from the HPLC pump, to the second valve, and to the HPLC column; and
fluid is flowed from the third valve, to the loop, back to the third valve and to an overflow vial.

3. The system of claim 1, which has a second fluid configuration in which the second valve is in the first orientation and the third valve is in a second orientation, wherein:
the loop contains a precursor reactive with the radiolabeling reagent to produce a radiolabeled compound;
(i) the radiolabeling reagent is flowed via the first input from the radiolabeling reagent source, (ii) the solvent is flowed via the second input from the solvent and inert gas source, or (iii) inert gas is flowed from an inert gas source, to (iv) the second valve, to the third valve, to the loop, back to the third valve, back to the second valve, and to the second output of the second valve;
fluid is pumped from the HPLC pump to the second valve and to HPLC column; and
fluid is flowed from the third valve to an overflow vial.

4. The system of claim 1, which has a third fluid configuration in which the second valve is in a second orientation and the third valve is in the second orientation, wherein:
the loop contains a precursor reactive with the radiolabeling reagent to produce a radiolabeled compound;
(i) the radiolabeling reagent is flowed via the first input from the radiolabeling reagent source, (ii) the solvent is flowed via the second input from the solvent and inert gas source, or (iii) inert gas is flowed from an inert gas source, to (iv) the second valve and to the second output of the second valve;
fluid is pumped from the HPLC pump to the second valve, to the third valve, to the loop, back to the third valve, back to the second valve and to the HPLC column; and
fluid is flowed from the third valve and to an overflow vial.

5. The system of claim 1, wherein:
the second valve includes a plurality of ports fluidly connected to different ones of each other in different orientations of the second valve; and
the third valve includes a plurality of ports fluidly connected to different ones of each other in different orientations of the third valve.

6. The system of claim 5, wherein the second valve and the third valve are rotatable to place the second valve and third valve in respective different orientations.

7. A system for the synthesis of radiolabeled compounds, comprising:
a radiolabeling reagent source;
a first input in fluid communication with the radiolabeling reagent source;
a solvent and inert gas source;
a second input in fluid communication with the solvent and inert gas source;
an HPLC pump;
a third input in fluid communication with the HPLC pump;
an HPLC column;
a loop;
a first valve in fluid communication with the first input and second input, the first valve having different selectable orientations;
a second valve in fluid communication with the third input, the second valve having a first output in fluid communication with the HPLC column, a second output, and different selectable orientations;
a third valve in fluid communication with the loop and the second valve, the third valve having different selectable orientations; and
a plurality of fluid pathways fluidly connecting the first input, the second input, the third input, the first output, the second output, the first valve, the second valve and the third valve;
wherein the system is positionable in different fluid configurations by placing the first valve, second valve and the third valve in respective selected orientations, the fluid pathways provide different fluid connections between the first input, the second input, the third input, the first output, the second output, the first valve, the second valve and the third valve in the different fluid configurations.

8. The system of claim 7, wherein the solvent and inert gas source includes a plurality of sources of different solvents, and the system further comprises:
a fourth valve in fluid communication with each of the plurality of sources of different solvents, the fourth valve having a plurality of orientations which selectively fluidly connect a single solvent source in fluid communication with the solvent and inert gas source outlet; and
a pressurized source of an inert gas in fluid communication with each of the plurality of sources of different solvents.

9. The system of claim 7, further comprising:
a radioisotope detector proximal to the loop; and
a control module in control communication with at least one of the first valve, the second valve and the third valve.

10. A system for the synthesis of radiolabeled compounds, comprising:
a first input fluidly connectable to a radiolabeling reagent source;
a second input fluidly connectable to a solvent and inert gas source;
a third input fluidly connectable to an HPLC pump;
a loop having first and second ports;
a first valve in fluid communication with the first input and the second input, the first valve having first and second orientations;
a second valve having a first output fluidly connectable to an HPLC column and a second output, the second valve being in fluid communication with the third input and the first valve, the second valve having first and second orientations;
a third valve in fluid communication with the loop and the second valve, the third valve having first and second orientations; and
a plurality of fluid pathways fluidly connecting the first input, the second input, the third input, the first output, the second output, the first valve, the second valve and the third valve;
wherein the plurality of fluid pathways in the first orientation of the first valve, of the second valve and of the third valve, (a) fluidly connect the first valve through the second valve to the third valve and back to the second valve, (b) fluidly connect the third valve with the first and second ports of the loop and back to the third valve, and (c) fluidly connect the third input to the first output through the second valve.

11. The system of claim 10, wherein the plurality of fluid pathways in the first orientation of the second valve and in the second orientation of the third valve fluidly connect the first valve to the second valve, the second valve to the third valve, the third valve to the loop, the loop back to the third valve, the third valve back to the second valve, and the second valve with the first output.

12. The system of claim 10, wherein the plurality of fluid pathways in the second orientation of the first valve, of the second valve, and of the third valve, fluidly connect the third input to the second valve, the second valve to the third valve, the third valve with the first port, the second port with the third valve, the third valve back with the second valve, and the second valve with the first output.

13. The system of claim 10, further comprising:
the solvent and inert gas source in fluid communication with the second input, the solvent and inert gas source including a plurality of sources of different solvents; and
a fourth valve in fluid communication with each of the plurality of sources of different solvents, the fourth valve having a plurality of orientations which selectively fluidly connect a single solvent source in fluid communication with the solvent and inert gas source.

14. The system of claim 13, further comprising a pressurized source of inert gas in fluid communication with each of the plurality of sources of different solvents.

15. The system of claim 13, further comprising a control module in control communication with at least one of the first valve, the second valve, the third valve and the fourth valve.

16. The system of claim 10, further comprising a radioisotope detector proximal to the loop.

17. The system of claim 10, further comprising the radiolabeling reagent source in fluid communication with the first input.

18. The system of claim 10, further comprising the HPLC pump in fluid communication with the third input.

19. The system of claim 10, further comprising the HPLC colunm in fluid communication with the first output.

20. The system of claim 10, further comprising a control module in control communication with at least one of the first valve, the second valve and the third valve.
